(19) United States
(12) Patent Application Publication
(10) Pub. No.: US 2005/0088734 A1
(43) Pub. Date: Apr. 28, 2005

(54) AUTONOMOUSLY ASSEMBLED SPACE TELESCOPE

(75) Inventor: Santanu Basu, Rancho Palos Verdes, CA (US)

Correspondence Address: ARTZ & ARTZ, P.C., 28333 TELEGRAPH RD., SUITE 250, SOUTHFIELD, MI, 48034, US

(73) Assignee: THE BOEING COMPANY, Chicago, IL (US)

(21) Appl. No.: 10/605,797

(22) Filed: Oct. 28, 2003

(51) Int. Cl. G02B 23/00

(52) U.S. Cl. 359/399; 359/857

(57) ABSTRACT

A method for autonomously assembling a segmented filled aperture telescope (“AAST”) in space using modular components that are launched into orbit using multiple launches. In one embodiment, a plurality of interlocking modular mirror backing structure segments, with or without an edge truss, are introduced to a satellite. To this are coupled a plurality of modular segmented optics to form a primary concave mirror. In another embodiment, the mirror backing structure and modular optics segments are formed as a single modular unit, with a plurality of these units coupled together to form the primary concave mirror. The modular concept allows primary mirrors of virtually limitless size to be formed in space with or without using astronauts.

### BACKGROUND OF INVENTION

The present invention generally relates to space optic systems and more specifically to an autonomously assembled space telescope.

The progress in large aperture telescopes has been quite remarkable over the last two decades. In space, the Hubble Space Telescope with a 2.4-meter monolithic primary mirror has been operating since 1993. Work on the James Webb Space Telescope (JWST) with a 6.5-meter deployable, segmented primary mirror has recently begun, and is scheduled for launch in 2011. In the ground-based optics arena, the 10-meter diameter Keck I and Keck II telescopes and 9.2-meter diameter Hobby Eberly telescopes became operational between 1992 and 1996.

In the past, considerable effort has been spent attempting to design reflective telescopes having larger and larger optics, but two basic difficulties have arisen: achieving and maintaining sub-wavelength tolerances over the large apertures, and designing telescopes which are light and compactly packaged for launch and eventual deployment into orbit. The telescope must be launchable (i.e., light weight and folded-up at launch) yet deploy to optical precision tolerances (fractional wavelengths). This has not yet been accomplished.

Realization of a large diameter space-based astronomical observatory would involve overcoming these difficulties. Launching such an instrument into orbit means that the payload mass of the observatory must be maintained as low as feasible. In some lightweight designs, optical or other components are not self-supporting in an earth gravity environment and thus cannot be fully or easily tested on earth prior to launch.

The payload mass capacity and fairing size of the launch vehicle limits the optics size. For example, the diameter of the largest commercial launch vehicle, the modified Delta Heavy, is approximately 4.5 m, and as such imposes a fundamental restriction on aperture size of the space telescopes. The deployable optical telescope, JWST, aims to overcome the fairing size limitation by launching a stowed telescope and deploying upon reaching orbit. Still, the size and mass constraints of the launch vehicle limit the primary diameter to 6.5 meters with the current state of technologies in segment, telescope structure and deployment.

It is highly desirable to design a telescope having significantly larger apertures without the need to redesign launch vehicles with larger payloads. It is also highly desirable that such telescopes be testable on the ground and easily reassembled in space.

### SUMMARY OF INVENTION

The present invention discloses a method for autonomously assembling a segmented filled aperture telescope (“AAST”) in space using components that are launched into orbit using multiple launches. Autonomous assembly will overcome the current limitations regarding the size of space optics, which is currently limited by the size of the launch vehicle.

The present invention will also enable significantly higher resolution astronomy through the use of larger apertures having a filled aperture design. The filled aperture design of the AAST gives better optical performance as compared with sparse aperture optics and multi-telescope systems due to the lack of side lobes and also due to the least post-processing of image data.

Further, the present invention may be potentially more cost effective because the components of the AAST can be robotically assembled in space to a high precision, and robotic assembly reduces the risk of requiring astronauts for assembly of large space optics.

Other objects and advantages of the present invention will become apparent upon considering the following detailed description and appended claims, and upon reference to the accompanying drawings.

### BRIEF DESCRIPTION OF DRAWINGS

FIG. 1 is a perspective view of an orbiting satellite having a reflecting telescope according to one preferred embodiment of the present invention.

FIG. 2 is a close-up backside view of the modular primary mirror segments of FIG. 1.

FIG. 3 is a side view of FIG. 2.

FIGS. 4A and 4B are close-up views of the modular mirror backing structure of FIG. 1 according to two preferred embodiments of the present invention.

FIGS. 5A-5F are perspective views for forming the mirror backing structures from the modular mirror backing structure segments of FIG. 4A.

FIGS. 6A-6G are perspective views for forming the mirror backing structures from the modular mirror backing structure segments of FIG. 4B.

FIG. 7 is a perspective view illustrating adding the modular primary mirror segments of FIGS. 2 and 3 to the mirror backing structure of FIG. 4A.

FIG. 8 illustrates a robot used to assemble the reflective telescope of FIG. 1 according to one preferred embodiment of the present invention.

FIG. 9 is a of the modular primary mirror segments of FIGS. 2 and 3 coupled to a multi-arm guide according to another preferred embodiment of the present invention.

FIG. 10 is a perspective view of a modular primary mirror of FIG. 9 being coupled to the mirror backing structure of FIG. 4A.

FIGS. 11 and 12 are perspective views of forming the primary mirror of FIG. 1 utilizing a modular primary mirror and mirror backing structure according to another preferred embodiment of the present invention.

FIG. 13 is a logic flow diagram for forming the reflecting telescope of FIG. 1 according to any of the embodiments described in FIGS. 2-12.

### DETAILED DESCRIPTION

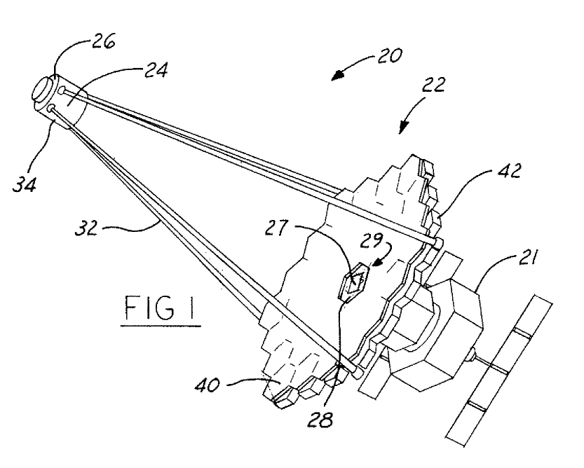

Referring now to FIG. 1, a reflecting telescope having a filled aperture design is shown generally as 20, herein shown contained on an orbiting satellite 21. Infrared and visible radiation from an astronomical object (e.g., a star) is collected, reflected and focused by a primary mirror 22 (preferably concave) towards a smaller secondary mirror 24 (preferably convex). Just before it gets to the focus the smaller secondary mirror 24 at the top 26 of the telescope 20 reflects this steeply converging beam of radiation and directs it downwards, now converging much more slowly, through a central hole 28 in the primary mirror 22 to an optical beam path 29 including an optional tertiary mirror 27, below, which directs it to an instrument focal station (not shown) contained within the satellite 21, wherein an onboard computer converts the data into a form that can be beamed to earth via communications satellites. The secondary mirror 24 has a support side surface 34 to which is coupled a plurality of support connectors 32. The data is translated and studied. Other portions of the satellite 21 and reflecting telescope 20 not relating directly to the primary mirror structure 22 and its associated structure are conventional and not discussed further herein.

Alternatively, the secondary mirror 24 may be coupled to a separate satellite (not shown) which hovers near the satellite containing the primary mirror 22. In addition, diagnostics systems (which check the alignment of the space telescope in real time), computer control systems, and other operational systems may be housed on a separate satellite. Operation of the space telescope 20 is thus coordinated between the two satellites.

The primary mirror 22 is formed of a plurality of modular segmented optics 40 spaced circumferentially around the central hole 28. Each of the segmented optics 40 have a precisely shaped front reflecting surface 44 made of ultra-low expansion glass. The front reflecting surface 44 is coated with a very thin layer of pure aluminum 46 and optionally protected by an even thinner layer of magnesium fluoride 48, which makes the mirrors 22 more reflective to ultraviolet light if desired.

Each of the segmented optics 40 is supported by a mirror backing structure that is coupled to the orbiting satellite 21. The mirror backing structure is also formed of modular components. The modular concept for the primary mirror may be formed in two fundamental ways.

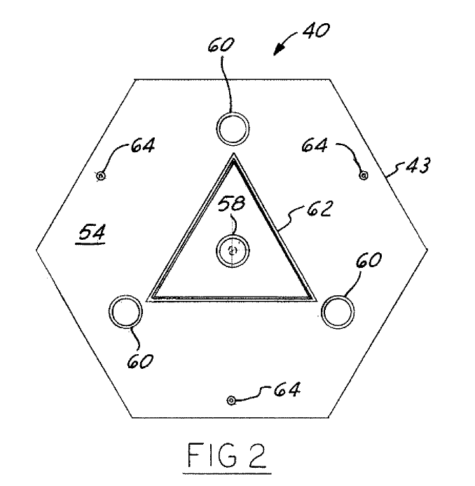

In one concept, the mirror backing structure 42 is first formed from a plurality of mirror backing structure segments 66. Next, modular segmented optics 40 are introduced one at a time to the coupled mirror backing structure 42. FIGS. 2-7 and 9-10 illustrate some of the different preferred embodiments formed in this way.

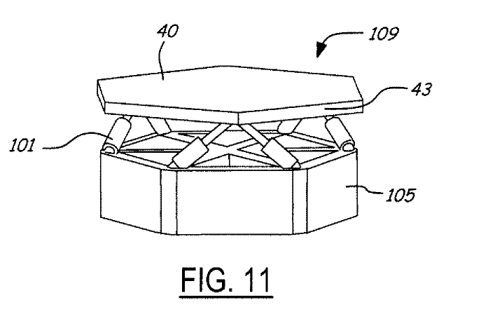

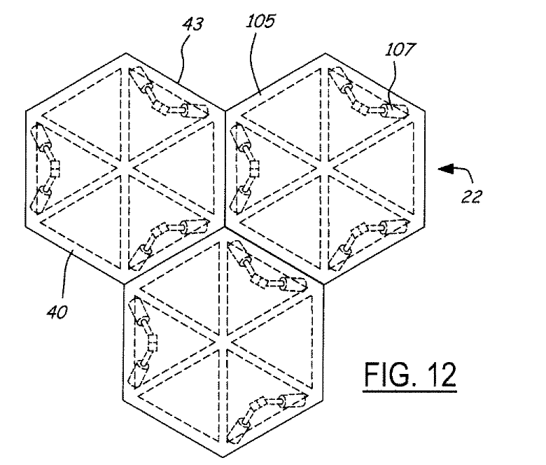

In another concept, as shown in FIGS. 11 and 12, the segmented optics and mirror backing structure are first formed into a single modular segment. These modular segments are then coupled together one at a time to form the primary mirror having the desired size and shape.

The concept for forming the modular primary mirror 22 addresses many of the issues found in prior art optics systems. First, because the primary mirror 22 is formed sequentially by coupling together plurality of smaller segmented optics 40 to a modular mirror backing structure 42, new optics systems can be designed in space without size limitation. As one of ordinary skill recognizes, larger optics will enable higher resolution astronomy and ground imaging, and will provide better efficiency of a space-based laser missile defense system.

Further, because the smaller modular segmented optics 40 and modular mirror backing segments are sized smaller than traditional telescopes, they can be more easily loaded onto a single launch vehicle or may be alternatively loaded onto multiple launch vehicles. By contrast, the size of monolithic telescopes (such as the Hubble Telescope) or deployable telescopes (such as the James Webb Space Telescope) is fundamentally limited by the storage compartment size of a single launch vehicle.

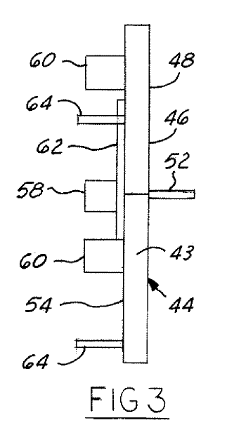

Referring now to FIGS. 2 and 3, a segmented optic 40 according to one preferred embodiment is illustrated having a precisely shaped, front reflecting surface 44 made of ultra-low expansion glass. The front reflecting surface 44 is coated with a very thin layer of pure aluminum 46 and optionally protected by an even thinner layer of magnesium fluoride 48, which makes the segments 40 more reflective to ultraviolet light, if operation in ultraviolet light is desired. An optional front grapple fixture 52 may also be present extending from the front reflecting surface 44. The side surfaces 43 of each segment may optionally have a built-in edge sensor (not shown).

On the backside 54 of each of the segmented optics 40, as best shown in FIG. 3, are a plurality of mechanical attachments, here shown as a flexible center attachment 58 and three actuator attachments 60. As will be discussed in further detail below, the size and shape of the attachments 58, 60, as well as the overall number of actuator attachments 60, are matters of design choice and function to fasten each of the segmented optics 40 to the mirror backing structure 42 securely and in a proper orientation to reflect light to the secondary mirror 24. In addition, the actuator attachments 60 allow the segmented optics 40 to move away from or towards the mirror backing structure 42 depending upon the desired focal length.

A guide 62 is also preferably added to the backside 54 that ensures that each of the segmented optics 40 is gently brought to the backing structure 42 without disturbing the neighboring segments 66 during assembly. The guide 62 is coarse-aligned before being fastened to the backing structure 42 through one or more fastening steps.

The backing structure 42 may have a corresponding guide (not shown) so that the segmented optics 40 are guided in the direction normal to the plane of the optics 40 and the backing structure 42 when the optics 40 are brought towards the backing structure 42 for assembly. The optics 40 are therefore constrained from translation in the plane of the optics and rotation. This facilitates the assembly process and aids in preventing damage to neighboring optics elements.

Also shown on the backside 54 of the segmented optics 40 is an optional rear grapple fixture 64 that may be used to aid in positioning the segmented optics 40 during assembly.

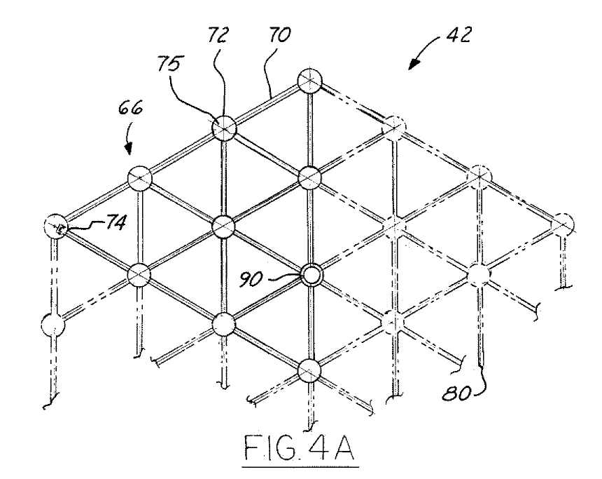

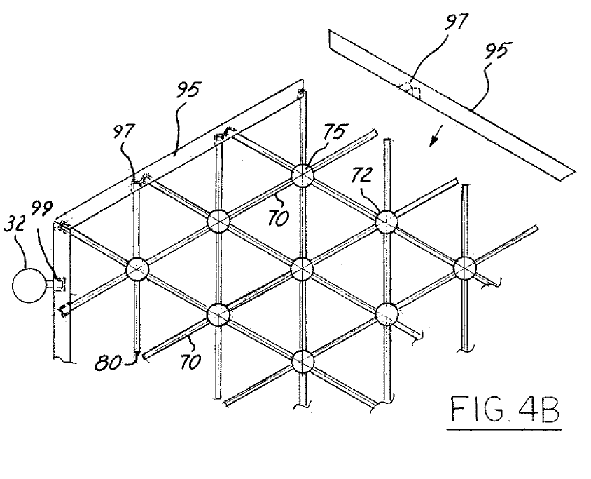

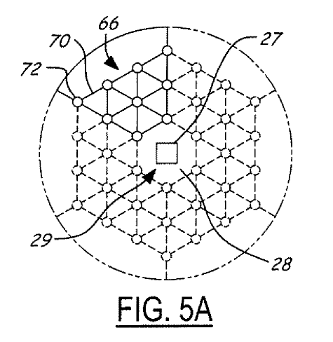

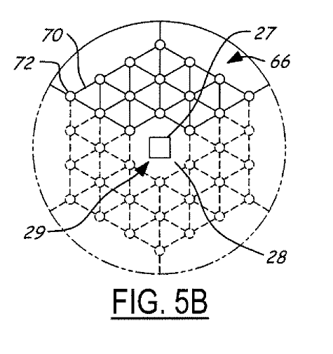

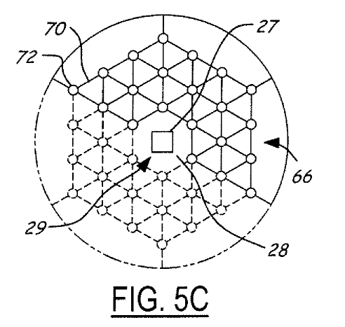

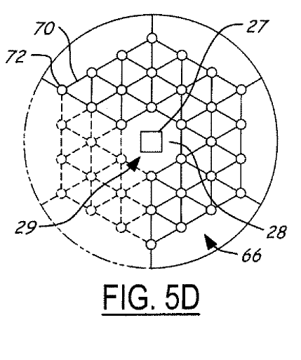

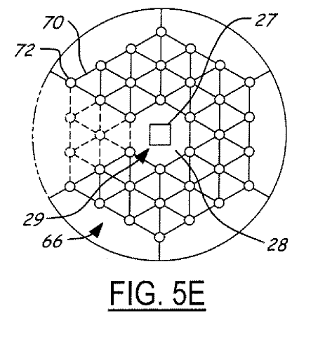

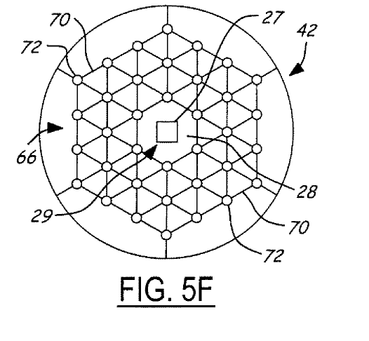

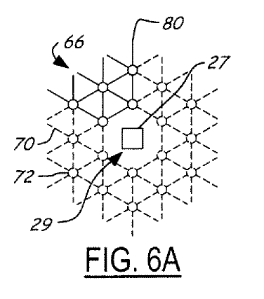

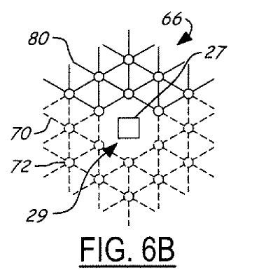

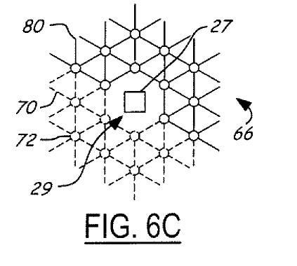

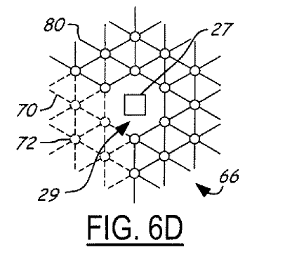

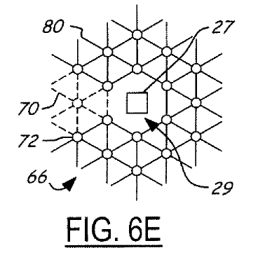

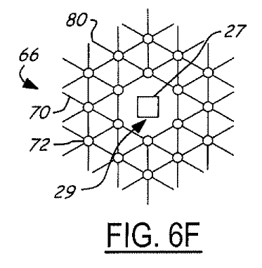

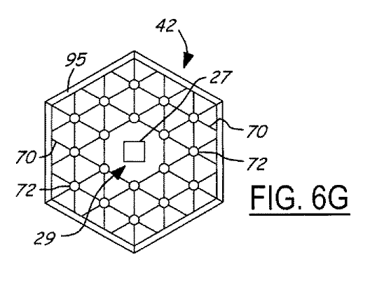

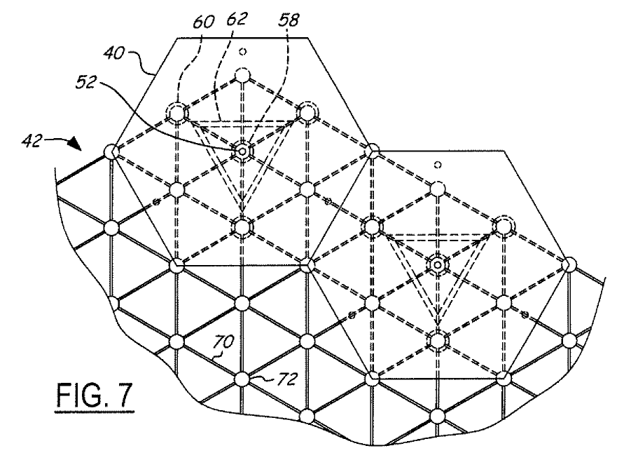

Each segmented optic 40 formed in FIGS. 2 and 3 above may then be coupled to a mirror backing structure 42 formed of a plurality of interlocking modular segments 66. One preferred embodiment of the mirror backing structure 42 is shown in FIGS. 4A and 5A-F, while another preferred embodiment of the mirror backing structure 42 is shown in FIGS. 4B and 6A-G. The method for coupling the segmented mirrors to either of the preferred mirror backing structures is then described in FIG. 7 below.

As best shown in FIGS. 4A and 5A, the mirror backing structure 42 has a plurality of interlocking modular segments 66, or trusses, that are used to support the overlying segmented optics 40. The modular segments 66 are shown as being preferably triangularly shaped, but may in fact take on any number of other shapes. Each segment 66 has a plurality of members 70 coupled together with interlocking attachments 72. Each of the interlocking attachments 72 has a plurality of side slots 74 shaped and sized to accept and retain a respective end 80 of a respective member 70. Each interlocking attachment 72 also has a top region 75 sized and shaped to correspond with the center and actuator attachments 58, 60 of the segmented optics 40 to couple the mirror backing structure 42 to each of the segmented optics 40. A guide (not shown) may be optionally attached to one or more of the respective trusses 66 or interlocking attachments 70, or both, that couples with the respective guide 62 to ensure that each respective segmented optic 40 is properly seated onto the mirror backing assembly 42 such that each of the segmented optics 40 may be gently brought to the backing structure 42 without disturbing the neighboring optics 40.

To form the mirror backing structure 42 of FIG. 4A, as best shown in FIGS. 5A-5F, the modular segments 66 are attached to each other one by one to form the desired shape. This is accomplished by inserting the open ends 80 of the members 70 of one segment 66 within a corresponding side slot 74 of an interlocking attachment 72 of an adjacent modular segment 66. In space, this can be accomplished through the use of robots, which can grab any of the adjacent modular segments 66 and guide the segment 66 towards the respective interlocking attachment 72.

The side slots 74 may be formed such that the trusses 66 extend substantially planar with respect to each other, or alternatively, so that the trusses 66 extend slightly upwardly or downwardly (i.e. each truss is not coplanar with respect to all other trusses 66 extending from the same interlocking structure) with respect to one another, therein allowing the segments 40 to be attached slightly non-planar with respect to each other to properly focus and reflect light towards the secondary mirror 24. The process of adding segments 66 is repeated until the mirror backing structure 42 has the desired number and arrangement of modular segments 66. Additional unused side slots 74 along the outer periphery of the formed mirror backing structure 42 may then be used as attachment points for a respective support connector 32 used to couple the secondary mirror 24 at a location distant from the primary mirror 22.

Referring now to FIG. 4B, the mirror backing structure 42 of FIG. 4A may alternatively be formed with a stabilizing edge truss 95 having a plurality of side slots 97 that is preferably coupled around the exterior of the formed mirror backing structure 42. The edge truss 95 functions to maintain the mirror backing structure 42 in a substantially planar alignment.

To form the mirror backing structure of FIG. 4B, as shown in FIG. 6A-6G, the modular segments 66 are attached to each other one by one to form the desired shape. This is accomplished by inserting the open ends 80 of one or more members 70 of one segment 66 within a corresponding side slot (shown as 74 in FIG. 4B) of an interlocking attachment 72 of an adjacent modular segment 66. In space, this can be accomplished through the use of robots, which can grab any of the adjacent modular segments 66 and guide the segment 66 towards the respective interlocking attachment 72.

The side slots 74 may be formed such that the trusses 66 extend substantially planar with respect to each other, or alternatively, so that the trusses 66 extend slightly upwardly or downwardly (i.e. each truss is not coplanar with respect to all other trusses 66 extending from the same interlocking structure) with respect to one another, therein allowing the segments 40 to be attached slightly non-planar with respect to each other to properly focus and reflect light towards the secondary mirror 24. The process of adding segments 66 is repeated until the mirror backing structure 42 has the desired number and arrangement of modular segments 66.

Next, as shown in FIG. 6G, the open ends 80 of the outermost members 66 are coupled within the slots 97 of the stabilizing edge truss 95. The slots 97 are sized similar to the slots 74, and may be formed to couple the trusses 66 at an angle or coplanar with respect to the edge truss 95. Additional slots 99 along the outer periphery of the stabilizing edge truss 95 may then be used to as attachment points for a respective support connector 32.

Next, as shown in FIG. 7, the segmented optics 40 are introduced, one at a time, onto the mirror backing structure 42 of either FIG. 4A or 4B to form the primary mirror 22. For ease of understanding, the segmented optics 40 as shown in FIG. 7 are being coupled to a mirror backing structure as discussed in FIGS. 4A and 5A-F above.

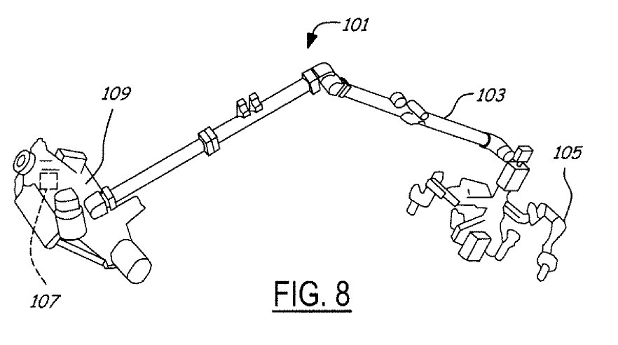

First, the segments 40 are moved into position adjacent to the mirror backing structure 42. To accomplish this movement in space, a robot (one preferred embodiment is shown as 101 in FIG. 8) grabs either the front 52 or rear grapple fixture 64 using pinchers 105 or other grabbing structure. The arms 103 move one or more segmented optics 40 in a controlled movement towards the mirror backing structure 42. The movement of the arms 103 and pinchers 105 is controlled by a control unit 107 mounted on a base structure 109 of the robot 101. The base structure 109 of the robot 101 is typically externally reversibly mounted on a portion of the satellite 21 that allows easy access to the respective components and mounting locations.

Next, the flexible center attachment 58 of one of the segmented optics 40 is coupled around (i.e. snapped onto) a respective top coupling 75 by moving the arm 103 and coupled respective segmented optic 40 further downward onto the top coupling 75.

Next, the respective actuator attachment 60 is coupled around an adjacent and corresponding adjacent top coupling 75 by continuing to move arm 103 further downward towards the mirror backing structure 42, therein snapping the actuator around the respective adjacent top coupling 75. The robot 101 continues to move the segmented optics 40 downward until the guide 62 is properly seated onto one or more of the trusses 66 or onto the respective guides 77. This ensures that each of the respective segmented optics 40 may be gently brought to the backing structure 42 without disturbing the previously coupled neighboring optics 40.

The process as described above is repeated to couple each additional segmented optic 40 to the mirror backing structure 42. Each additional segment 40 is coupled such that the nearest side edges 43 substantially abut one another such that the front reflective surfaces 44 are substantially coplanar with respect to each other. The optional edge sensors ensure that adjacent segmented optics 40 are properly aligned with the next adjacent segmented optics along each respective side surface 43.

Of course, in alternative preferred embodiments, the attachment between each respective segmented optic 40 and the mirror backing structure may be accomplished in a wide variety of different ways. For example, while FIGS. 2-7 illustrate wherein the attachments 58, 60 are coupled around a respective top coupling 75; just the opposite is also possible. Thus, in this system, the top coupling 75 may be hollow (shown as 90 on FIG. 4A) and the center attachments 58 and actuator attachments 60 may be shaped to be inserted within the respective hollowed region 90.

Further, while the shape of the attachments 58, 60 and respective top coupling 75 is shown as circular and rod-like, respectively, the attachments may in fact be any number of shapes. For example, the attachments could be triangularly shaped and the top coupling could have a triangular rod shape that is inserted within the inner regions of the attachments 58, 60.

In addition, alternative and/or additional attachment structures may be added to the attachments. For example, screws or an adhesive may be introduced to fasten the center attachment 58 or actuator attachments 60 to the respective top coupling 75. In addition, external couplers (not shown) may be used to attach the center attachment or actuator attachments to the respective top coupling.

While one preferred embodiment of a robot 101 is shown in FIG. 8, it is understood by those of ordinary skill in the art that virtually any type of robot typically available for space applications may be utilized to move and attach the segmented optics 40 to the respective mirror backing structure 42. While the use of a robot 101 is preferred for this application, it is understood that it is not necessary. For example, astronauts may perform all of the tasks in space described above by the robot 101 to form the primary mirror 22.

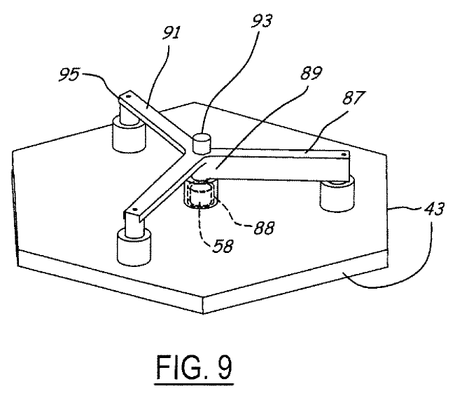

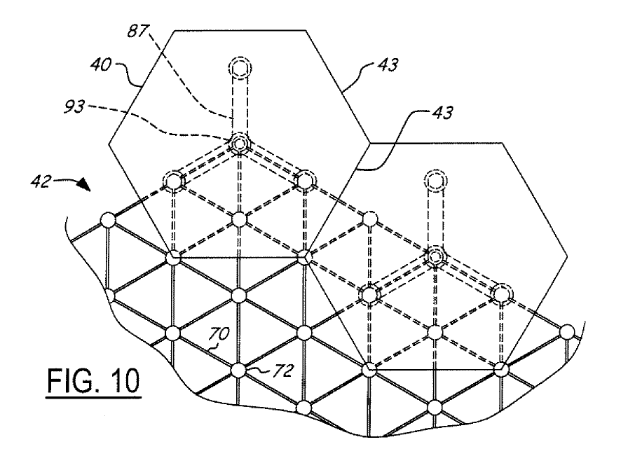

In another alternative embodiment as shown in FIGS. 9 and 10, a multi-arm guide 87 is introduced into each of the segmented optics 40 prior to coupling the segmented optics 40 to the mirror backing structure 42. The multi-arm guide 87 provides a method for ensuring that the segmented optic 40 is properly seated onto the mirror backing structure 42 at the proper angle and orientation. The multi-arm guide 87 also assures that the mirrors are positioned at the ideal focal length from the secondary mirror 24 for the particular application.

In this preferred embodiment, the center attachment 58 of the segmented optic 40 is coupled within an inlet region 88 of a multi-arm guide 87. Of course, the center attachment 58 could alternatively be coupled around the inlet region 88. The inlet region 88 is contained within one side of a central hub 89. The central hub 89 also has a protruding region 93 located on the opposite side of the inlet region 88 that couples within the hollow portion 90 of the top coupling 75. Extending radially outward from the central hub 89 are arms 91 that are coupled over each respective actuator attachment 60. Again, in alternative preferred embodiments, it is equally likely that the actuator attachment could be coupled around the lower portion of the arms and achieve the same effect. The outer surfaces 95 of the arms 91 are then seated onto the respective trusses 66 to ensure that the mirror segment 40 is properly aligned on the trusses 66. Edge sensors contained on the edge regions 43 ensure that each respective segment 40 is properly aligned.

In another preferred embodiment, as shown in FIGS. 11 and 12, each modular segmented optics 40 is first coupled to modular portion, or reaction structure 105, of the mirror backing structure 42 via face sheet actuators 107 to form a single, integrated modular segment 109.

A plurality of integrated modular segments 109 are then coupled together in space in the desired shape such that the edges 43 of each modular segmented optic 40 abut an adjacent edge 43 of the next adjacent modular segment 109 and such that the top reflective surfaces 44 are formed with a continuous surface at a proper angle with respect to the secondary mirror 24 and the optical beam path 26 to ensure minimum wavefront distortion upon reflection from the primary mirror 22. An external coupler or internal coupler (not shown) attached to the reaction structure 105 is utilized to fasten each integrated modular segment 109 to the next adjacent integrated modular segment in the desired pattern. In addition, the integrated segments 109 are preferably formed with coupling regions (not shown) on its outer periphery that can be used to attach to the support connectors 32 of the secondary mirror 24.

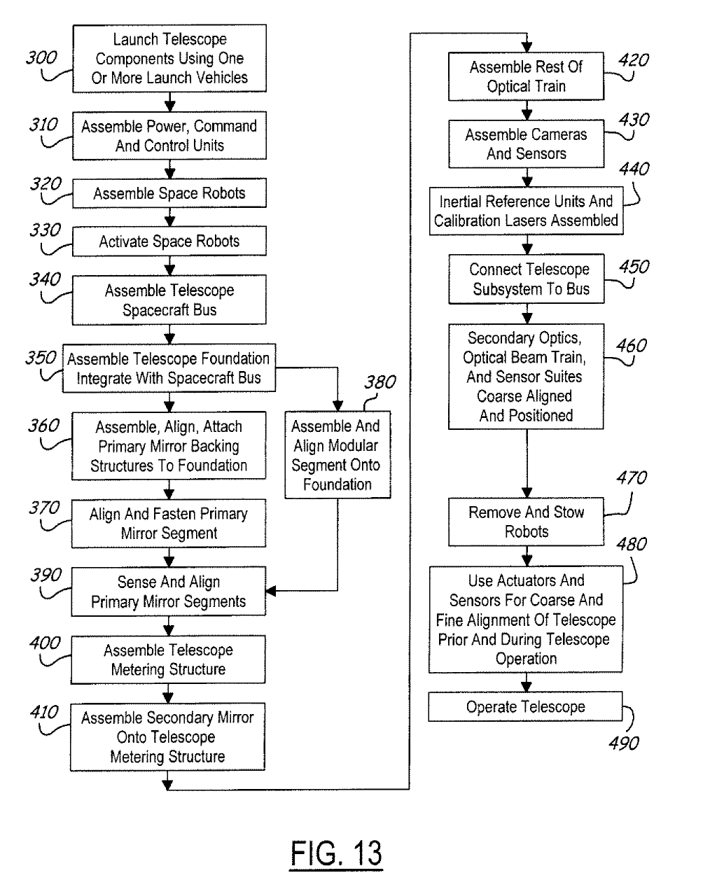

FIG. 13 illustrates a logic flow diagram for forming a space telescope 20. Beginning with Step 300, the telescope components are launched in one or more payloads using one or more launch vehicles. One payload becomes the central satellite 21 with a foundation for an optical structure. The other payloads bring components to the central satellite for completion of the assembly 20 over time. The other payloads may also bring other components for telescope operations. The payload of any one or more launch vehicles may contain one or more segmented optics 40, mirror backing structure segments 66, and/or robots 101 as shown in FIGS. 1-10 above. The payload may alternatively have one or more modular optics 109 as described above in FIGS. 11 and 12.

Next, in Step 310, the power, command, and control units are assembled. These assembled units are subsequently used to assemble the space robotics, as shown in Step 320. As multiple robotics may be needed (one for the primary mirror, one for the sensors etc.), it may be necessary to assemble a guide and support structure, through which the multiple space robots are tethered at various parts of the telescope. The space robotics are activated in Step 330.

In Step 340, the telescope spacecraft bus is assembled including power, thermal, computer, orbital, attitude adjustment subsystems, command units, and control units. Next, in Step 350, the telescope foundation is assembled and integrated with the telescope spacecraft bus.

Next, the primary mirror and mirror backing structure are assembled, aligned, and attached to the telescope foundation to act as a single unit. Steps 360 and 370 describe these methods with respect to the embodiments as described FIGS. 2-10, while Step 380 describes the method with respect to the modular segment 109 of FIGS. 11 and 12.

In Step 360, the primary mirror backing structures 42 are assembled, aligned, and attached to the telescope foundation to act as a single unit. In Step 370, each primary mirror segment 40 or a subassembly with multiple mirror segments are aligned and fastened onto the primary mirror support structure as described above in FIG. 5A-F or 6A-G, preferably through the use of space robots.

For FIGS. 11 and 12, alternatively, as shown in Step 380, each modular segment 109 is aligned in the desired pattern onto the telescope foundation utilizing the space robots such that the edges 43 of the adjacent segments 109 properly abut and such that the top reflective surfaces 44 are aligned in a continuous fashion to form the primary mirror 22, and to optimize for maximum optical throughput and minimum wavefront distortion.

In Step 390, the primary mirror segments are sensed and aligned with respect to each other to meet a coarse piston/tilt error budget. Next, in Step 400, the telescope metering structure is assembled. In Step 410, the secondary mirror is assembled onto the telescope metering structure.

In Step 420, the remainder of the optical train is assembled. This includes optical beam path 29, optional tertiary mirror 27, and relay optics. In Step 430, the cameras and sensors are assembled at one or more imaging locations. In Step 440, other optical sources such as inertial reference units and calibration lasers are assembled and coupled to the telescope structure.

Next, in Step 450, connections are made to the power, thermal, computer, command and control units between the telescope subsystem and telescope spacecraft bus. In Step 460, the secondary optics, optical beam train, and sensor suites are coarse aligned and positioned with respect to the primary mirror and the telescope. Next, in Step 470, the robotics are removed and stowed if necessary.

In Step 480, the actuators and sensors will make initial alignments that will be used during the design mission by the telescope spacecraft. The alignment mode will transition from coarse alignment to fine optical alignment requiring tens of nanometer distance and milli-arcsecond levels of angular resolution. Finally, in Step 490, the optical telescope 21 is made operable.

The present invention thus addresses many of the issues found in prior art optics systems. First, new optics systems can be designed in space without size limitation. These larger optics will enable higher resolution astronomy and ground imaging, and will provide better efficiency of a space-based laser missile defense system.

Further, because the segmented optics and mirror backing structure are modular components, the size of the optics systems is not limited fundamentally by the space constraints of a single launch vehicle, as is the case with monolithic telescopes (such as the Hubble Telescope) or deployable telescopes (such as the James Webb Space Telescope). Instead, the components may be launched on multiple launch vehicles, therein allowing the size of the primary mirror to be increased incrementally over time.

In addition, because the smaller segments 40, 66 may be packed more efficiently within a single launch vehicle, other non-related space components (not shown) may be added to the saved space within the payload area of the launch vehicle. This adds increased flexibility and cost savings associated with a single vehicle launch.

Also, the components of the present invention may be autonomously assembled in space using a simple robotic device 101. This is desirable for a number of reasons. First, because the mirror will operate in space (i.e. in zero gravity), additional support structures, such as the whiffletree structures added to the mirror backing structure of Keck Telescope (which is operated on earth) to prevent sagging of the backing structure under the weight of the primary mirror structure, are not necessary. Also, by assembling the components using robotic devices, astronaut lives will not have to be put at risk for the purpose of building larger telescopes in space.

Finally, while not shown, one or more additional satellites may be used in conjunction with the primary central satellite to further improve the performance of the space telescope. These additional satellites can be fitted with additional modular segmented optics and associated backing structures as described above in FIGS. 2-7 and 9-12. These additional satellites may house the secondary mirror (or additional secondary mirrors), additional diagnostics systems that check telescope alignment in real time, computer systems, or control systems designed in conjunction with the space telescope as substantially shown in FIG. 1 to further improve and coordinate operation of the space telescope. In addition, these additional satellites may be used to form the space telescope as described in FIGS. 1-12.

While the invention has been described in terms of preferred embodiments, it will be understood, of course, that the invention is not limited thereto since modifications may be made by those skilled in the art, particularly in light of the foregoing teachings.

1. A filled aperture reflecting telescope primarily used for deep space applications comprising:
a primary mirror comprising a plurality of modular segmented optics coupled to a modular mirror backing structure, wherein said modular mirror backing structure is formed from a plurality of interlocking mirror backing structure segments;
a central hole defined within said primary mirror;
a secondary mirror operatively coupled to said primary mirror; and
an optical beam path having an optional tertiary mirror, said optical beam path being operatively coupled to said secondary mirror through said central hole.

2. The reflecting telescope of claim 1, wherein each of said plurality of modular segmented optics comprises:
a front reflecting surface;
a backside;
a plurality of side surfaces defined by said front reflecting surface and said backside;
an optional front grapple fixture coupled to said front reflecting surface;
a flexible center attachment coupled to said backside;
a plurality of actuator attachments coupled to said backside;
an optional guide attached to said backside; and
an optional rear grapple fixture attached to said backside.

3. The reflecting telescope of claim 2, wherein a first one of said plurality of modular segmented optics is coupled to an adjacent one of said plurality of modular segmented optics such that a first side surface of said first one of said plurality of modular segmented optics substantially abuts an adjacent side surface of said adjacent one of said plurality of modular segmented optics and such that said front reflecting surface of said first one of said plurality of modular segmented optics forms a continuous surface with said front reflecting surface of said adjacent one of said plurality of modular segmented optics.

4. The reflecting telescope of claim 1, wherein each of said modular interlocking mirror backing segments comprises:
at least one interlocking attachment(s), each of said at least one interlocking attachments having a plurality of side slots and a top region; and
a plurality of members coupled to at least one of said at least one interlocking attachments.

5. The reflecting telescope of claim 1 further comprising a plurality of support connectors coupled to said secondary mirror and to said mirror backing structure.

6. The reflective telescope of claim 1 further comprising an edge truss coupled around said modular mirror backing structure.

7. The reflecting telescope of claim 6 further comprising a plurality of support connectors coupled to said secondary mirror and to said edge truss.

8. The reflective telescope of claim 2, wherein each of said modular interlocking mirror backing segments comprises:
at least one interlocking attachment(s), each of said at least one interlocking attachments having a plurality of side slots and a top region; and
a plurality of members coupled to at least one of said at least one interlocking attachments, wherein said center attachment and each of said actuator attachments of each of said plurality of modular optics segments is coupled to a respective top region of said modular interlocking mirror backing segments.

9. The reflective telescope of claim 8, wherein said center attachment is coupled to said top region of one of said at least one interlocking attachments.

10. The reflective telescope of claim 8, wherein said at least one interlocking attachment comprises a plurality of interlocking attachments.

11. The reflective telescope of claim 10, wherein said center attachment is coupled to said top region of one of said plurality of interlocking attachments and wherein each of said plurality of actuator attachments is coupled with a respective top region of another of said plurality of actuator attachments.

12. The reflective telescope of claim 10 further comprising a multi-arm guide coupled between one of said plurality of modular optics segments and said mirror backing structure, said multi-arm guide comprising:
a central hub having an inlet region and a protruding region, said inlet region coupled to said center attachment and wherein said protruding region is coupled with a top surface of said at least one interlocking attachment; and
a plurality of arms extending radially from said central hub, each of said arms coupled over a respective one of said plurality of actuator attachments and seated onto at least one of said plurality of members.

13. A filled aperture reflecting telescope primarily used for space applications comprising:
a primary mirror comprising a plurality of coupled integrated modular segments, wherein each of said interlocking modular segments comprises a segmented optic coupled to a reaction structure using at least one face sheet actuator, said segmented optic comprises:
a front reflecting surface; a backside and a plurality of side surfaces defined by said front reflecting surface and said backside;
a central hole defined within said primary mirror;
a secondary mirror operatively coupled to said primary mirror; and
an optical beam path operatively coupled to said secondary mirror through said central hole, said optical beam path having an optional tertiary mirror.

14. The reflecting telescope of claim 13, wherein a first one of said plurality of integrated modular segments is coupled to an adjacent one of said plurality of modular segmented optics such that a first side surface of said first one of said plurality of integrated modular segments substantially abuts an adjacent side surface of said adjacent one of said plurality of integrated modular segments and such that said front reflecting surface of said first one of said plurality of integrated modular segments forms a continuous surface with said front reflecting surface of said adjacent one of said plurality of integrated modular segments.

15. The reflecting telescope of claim 14 further comprising an external coupler used to couple said first one of said plurality of integrated modular segments to said adjacent one of said plurality of modular segmented optics.

16. The reflecting telescope of claim 13 further comprising a plurality of support connectors coupled to said secondary mirror, each of said plurality of support connectors further being coupled to a respective different outermost one of said plurality of integrated modular segments, each of said outermost respective one of said plurality of integrated modular segments being located furthest from said central hole.

17. The reflecting telescope of claim 13 further comprising a plurality of support connectors coupled to said secondary mirror, each of said plurality of support connectors further being coupled to a respective different outermost reaction structure of one of said plurality of integrated modular segments, each of said outermost respective one of said outermost reaction structures being located furthest from said central hole.

18. A method for forming a reflective telescope comprising:
providing a satellite having a foundation of an optical structure, said optical structure including an optical beam path having an optional tertiary mirror;
forming a plurality of interlocking modular segments, each of said plurality of interlocking modular segments comprising a plurality of interlocking attachments and a plurality of members, wherein each of said plurality of interlocking attachments is coupled to at least one said plurality of members and wherein each of said plurality of members is coupled with at least one of said plurality of interlocking attachments;
forming a modular mirror backing structure from said plurality of interlocking modular segments;
coupling said modular mirror backing structure to said foundation
coupling a plurality of modular segmented optics one at a time to said modular mirror backing structure to form a primary mirror having a central hole; and
coupling a secondary mirror to said modular mirror backing structure, wherein said secondary mirror is operatively coupled to said primary mirror and is operatively coupled said optical beam path through said central hole.

19. The method of claim 18, wherein forming a plurality of interlocking modular segments comprises:
providing a plurality of interlocking attachments, each of said plurality of interlocking attachments having a top region and a plurality of side slots;
providing a plurality of members having a first end and a second end;
introducing a first end of one of said plurality of members within a first side slot of one of said plurality of interlocking attachments;
introducing a second end of said one of said plurality of members within a first side slot of a second one of said plurality of interlocking attachments; and
introducing a first end of another of said plurality of members within a second side slot of said first one of said plurality of interlocking attachments.

20. The method of claim 18, wherein forming a modular mirror backing structure from said plurality of interlocking modular segments comprises coupling a first end of one of said plurality of members of one of said plurality of interlocking modular segments within a first side slot of another one of said plurality of interlocking modular segments; and
introducing a first end of another one of said plurality of members of said one of said plurality of interlocking modular segments within a first side slot of a third one of said plurality of interlocking modular segments.

21. The method of claim 19, wherein coupling a secondary mirror to said modular mirror backing structure comprises:
providing at least one support connector, each of said at least one support connectors having a inner end and an outer end;
coupling an outer end of each of said at least one support connector to an outer side surface of said secondary mirror;
coupling an inner end of each of said at least one support connector to a respective one of said at least one interlocking attachments, each of said respective ones of said at least one interlocking attachment defining an outer periphery of said modular mirror backing structure.

22. The method of claim 18 further comprising introducing said outermost end of each of said plurality of members defining said outer periphery within a corresponding inner side slot of an edge truss.

23. The method of claim 22, wherein coupling a secondary mirror to said modular mirror backing structure comprises:
providing at least one support connector, each of said at least one support connectors having a inner end and an outer end;
coupling an outer end of each of said at least one support connector to an outer side surface of said secondary mirror;
coupling an inner end of each of said at least one support connector to a respective outer side slot of said edge truss.

24. The method of claim 19, wherein coupling a plurality of modular segmented optics one at a time to said modular mirror backing structure comprises:
(a) forming a plurality of modular segmented optics, wherein each of said plurality of modular segmented optics comprises a front reflecting surface; a backside; a plurality of side surfaces defined by said front reflecting surface and said backside; an optional front grapple fixture coupled to said front reflecting surface; a flexible center attachment coupled to said backside; a plurality of actuator attachments coupled to said backside; an optional guide attached to said backside; and an optional rear grapple fixture attached to said backside;
(b) coupling a flexible center attachment of a first one of said plurality of modular segmented optics to a top region of one of said interlocking attachments; and
(c) coupling each of said plurality of actuator attachments of said one of said plurality of modular segmented optics to a respective top region of another of said plurality of interlocking attachments;
(d) repeating steps (b) and (c) for an adjacent one of said segmented optics, wherein a first side surface of said first one of said plurality of modular segmented optics substantially abuts an adjacent side surface of said adjacent one of said plurality of modular segmented optics and such that said front reflecting surface of said first one of said plurality of modular segmented optics forms a continuous surface with said front reflecting surface of said adjacent one of said plurality of modular segmented optics.

25. The method of claim 24 further comprising (f) repeating step (e) for at least one more of said plurality of modular segmented optics.

26. The method of claim 24, wherein (b) coupling a flexible center attachment of a first one of said plurality of modular segmented optics to a top region of one of said interlocking attachments comprises:
providing a robot having a base structure having a control unit, an arm, and a grabbing structure, wherein said control unit controls the movement of said arm and said grabbing structure;
coupling said robot to said front grapple fixture of a first one of said plurality of modular segmented optics;
moving said arm of said robot towards said a plurality of interlocking modular segments;
moving said arm of said robot further towards said plurality of interlocking attachments to couple said center attachment to a respective top region of one of said interlocking attachments;
moving said arm of said robot further towards said plurality of interlocking attachments to couple said actuator attachment to a respective top region of a respective another one of said interlocking attachments;
moving said arm of said robot further towards said plurality of interlocking attachments until said optional guide is seated against one or more of said plurality of members; and
uncoupling said robot from said front grapple fixture.

27. The method of claim 24, wherein (b) coupling a flexible center attachment of a first one of said plurality of modular segmented optics to a top region of one of said interlocking attachments comprises:
providing a robot having a base structure having a control unit, an arm, and a grabbing structure, wherein said control unit controls the movement of said arm and said grabbing structure;
coupling said robot to said rear grapple fixture of a first one of said plurality of modular segmented optics;
moving said arm of said robot towards said a plurality of interlocking modular segments;
moving said arm of said robot further towards said plurality of interlocking attachments to couple said center attachment to a respective top region of one of said interlocking attachments;
moving said arm of said robot further towards said plurality of interlocking attachments to couple said actuator attachment to a respective top region of a respective another one of said interlocking attachments;
moving said arm of said robot further towards said plurality of interlocking attachments until said optional guide is seated against one or more of said plurality of members; and
uncoupling said robot from said rear grapple fixture.

28. The method of claim 19, wherein coupling a plurality of modular segmented optics one at a time to said modular mirror backing structure comprises:
(a) forming a plurality of modular segmented optics, wherein each of said plurality of modular segmented optics comprises a front reflecting surface; a backside; a plurality of side surfaces defined by said front reflecting surface and said backside; an optional front grapple fixture coupled to said front reflecting surface; a flexible center attachment coupled to said backside; a plurality of actuator attachments coupled to said backside; an optional guide attached to said backside; and an optional rear grapple fixture attached to said backside;
(b) providing a plurality of multi-arm guides, wherein each of said plurality of multi-arm guide comprises a central hub having an inlet region and a protruding region, and a plurality of arms extending radially from said central hub;
(c) introducing said center attachment of one of said plurality of multi-arm guides within an inlet region of a multi-arm guide such that said plurality of arms are coupled over a respective one of said plurality of actuator attachments;
(d) coupling said multi-arm guide of a first one of said plurality of modular segmented optics to a top region of one of said interlocking attachments; and
(e) repeating steps (b) and (c) for an adjacent one of said segmented optics, wherein a first side surface of said first one of said plurality of modular segmented optics substantially abuts an adjacent side surface of said adjacent one of said plurality of modular segmented optics and such that said front reflecting surface of said first one of said plurality of modular segmented optics forms a continuous surface with said front reflecting surface of said adjacent one of said plurality of modular segmented optics.

29. The method of claim 28, wherein (d) coupling said multi-arm guide of a first one of said plurality of modular segmented optics to a top region of one of said interlocking attachments comprises:
coupling said protruding region with a top surface of said at least one interlocking attachment such that each of said arms coupled over a respective one of said plurality of actuator attachments is seated onto at least one of said plurality of members.

30. A method for forming a space telescope comprising:
providing a satellite having a foundation of an optical structure, said foundation having an optical beam path having an optional tertiary mirror;
forming a primary mirror having a central hole, said primary mirror comprising a plurality of coupled integrated modular segments, wherein each of said integrated modular segments comprises a segmented optic coupled to a reaction structure using at least one face sheet actuator;
coupling said primary mirror to said foundation, wherein said optical beam path is closely coupled with said central hole; and
coupling a secondary mirror to said modular mirror backing structure, wherein said secondary mirror is operatively coupled to said optical beam path through said central hole and is operatively coupled to said primary mirror.

31. The method of claim 30, wherein forming a primary mirror comprises:
(a) providing a plurality of segmented optics, each of said segmented optics having a front reflecting surface, a backside, and a plurality of side surfaces defined by said front reflecting surface and said backside;
(b) providing a plurality of reaction structures;
(c) coupling at least one face sheet actuator to each of said plurality of reaction structures;
(d) coupling one of said plurality of segmented optics to a respective one of said plurality of reaction structures using said one of said at least one face sheet actuator to form an integrated modular segment; and
(e) coupling one of said integrated modular segments to another of said integrated modular segments such that said front reflecting surface of said first one of said integrated modular segments forms a continuous surface with said front reflecting surface of said another one of said integrated modular segments and wherein a respective one of said side surfaces of said one of said integrated modular segments substantially abuts a respective one of said side surfaces of said another one of said integrated modular segments.

32. The method of claim 31, wherein said one of said integrated modular segments is coupled to said another of said integrated modular segments using an external coupler.

33. A method for forming a space telescope comprising:
forming a payload which can be launched into space;
forming a plurality of interlocking modular segments, each of said plurality of interlocking modular segments comprising a plurality of interlocking attachments and a plurality of members, wherein each of said plurality of interlocking attachments is coupled to at least one said plurality of members and wherein each of said plurality of members is coupled with at least one of said plurality of interlocking attachments;
forming a plurality of modular segmented optics;
introducing a portion of said plurality of interlocking modular segments and a portion of said plurality of modular segmented optics to said payload;
launching said payload into space orbit using a launch vehicle, said payload operating as a satellite and having a foundation and an optical structure, said optical structure including an optical beam path having an optional tertiary mirror;
forming a modular mirror backing structure from said portion of said plurality of interlocking modular segments;
coupling said modular mirror backing structure to said foundation;
coupling said portion of said plurality of modular segmented optics one at a time to said modular mirror backing structure to form a primary mirror having a central hole; and
coupling a secondary mirror to said modular mirror backing structure, wherein said secondary mirror is operatively coupled to said primary mirror and is operatively coupled to said optical beam path through said central hole.

34. The method of claim 33, wherein a first one of said plurality of modular segmented optics is coupled to an adjacent one of said plurality of modular segmented optics such that a first side surface of said first one of said plurality of modular segmented optics substantially abuts an adjacent side surface of said adjacent one of said plurality of modular segmented optics and such that a front reflecting surface of said first one of said plurality of modular segmented optics forms a continuous surface with said front reflecting surface of said adjacent one of said plurality of modular segmented optics

35. The method of claim 33 further comprising increasing the size of said primary mirror by:
introducing at least one more of said plurality of interlocking modular segment to said modular mirror backing structure to form a larger modular mirror backing structure; and
introducing at least one more of said plurality of modular segmented optics one at a time to said larger modular mirror backing structure.

36. The method of claim 35, wherein increasing the size of the space telescope comprises:
introducing a second portion of said plurality of interlocking modular segments and a second portion of said plurality of modular segmented optics to a second payload;
launching said second payload into space using a second launch vehicle;
docking said second payload to said satellite;
introducing at least one of said second portion of said plurality of interlocking modular segments to said modular mirror backing structure to form a larger modular mirror backing structure; and
introducing at least one of said second portion of said plurality of modular segmented optics to said larger modular mirror backing structure.

37. The method of claim 33 further comprising coupling an edge truss to an outermost end of each of said plurality of members defining an outer periphery of said modular mirror backing structure.

38. A method for forming a space telescope comprising:
forming a plurality of coupled integrated modular segments, wherein each of said integrated modular segments comprises a segmented optic coupled to a reaction structure using at least one face sheet actuator;
introducing a portion of said plurality of coupled integrated modular segments to a payload;
launching said payload into space using a launch vehicle;
docking said payload to a satellite having a foundation for an optical structure, said optical structure including an optical beam path and an optional tertiary mirror;
coupling a plurality of said coupled integrated modular segments one at a time to said foundation to form a primary mirror having a central hole; and
coupling a secondary mirror to said modular mirror backing structure, wherein said secondary mirror is operatively coupled to optical beam path through said central hole and wherein said secondary mirror is operatively coupled to said primary mirror.

39. The method of claim 38, wherein a first one of said plurality of integrated modular segments is coupled to an adjacent one of said plurality of modular segmented optics such that a first side surface of said first one of said plurality of integrated modular segments substantially abuts an adjacent side surface of said adjacent one of said plurality of integrated modular segments and such that a front reflecting surface of said first one of said plurality of integrated modular segments forms a continuous surface with said front reflecting surface of said adjacent one of said plurality of integrated modular segments.

40. The method of claim 38 further comprising increasing the size of the primary mirror by:
introducing a second portion of said plurality of coupled integrated modular segments to at least one other payload(s);
launching each of said at least one other payload into space using a respective launch vehicle;
docking each of said at least one other payload one at a time to said foundation of said satellite; and
coupling said second portion of said plurality of coupled integrated modular segments one at a time to said foundation to increase the size of said primary mirror.

41. The method of claim 38 further comprising:
coupling the operation of said space telescope with one or more additional satellites.

42. The method of claim 38 further comprising:
providing one or more additional satellites in orbit; and
utilizing said one or more additional satellites to couple said plurality of said coupled integrated modular segments one at a time to said foundation to form a primary mirror having a central hole.
